(19) United States
(12) Patent Application Publication
(10) Pub. No.: US 2006/0182924 A1
(43) Pub. Date: Aug. 17, 2006

(54) Optical data recording medium provided with at least one photosensitive layer and one deformable layer

(75) Inventors: Philippe Cornu, Mayenne (FR); Berangere Hyot, Grenoble (FR); Ludovic Poupinet, Sassenage (FR)

Correspondence Address: OLIFF & BERRIDGE, PLC, P.O. BOX 19928, ALEXANDRIA, VA, 22320, US

(73) Assignees: Commissariat a L'energie Atomique, Paris (FR); MPO International, Averton (FR)

(21) Appl. No.: 10/561,832

(22) PCT Filed: Jul. 16, 2004
(86) PCT No.: PCT/FR04/01897

§ 371 Date: Dec. 22, 2005

(30) Foreign Application Priority Data
Jul. 21, 2003 (FR) 0308875

(51) Int. Cl. B32B 3/02

(52) U.S. Cl. 428/64.1

(57) ABSTRACT

An optical recording medium comprises first and second substrates wherebetween there is arranged at least one first photosensitive layer, preferably made of inorganic material. The first photosensitive layer comprises a front face for receiving optical radiation, by means of the second substrate, during data writing and/or reading operations. A first deformable layer, transparent to the optical radiation, is arranged between the first photosensitive layer and the second substrate. The first substrate comprises a patterned front face, so as to form a preferably spiral-shaped groove enabling precise data writing and/or reading to be performed by means of an automatic focusing control and track monitoring system.

### BACKGROUND OF THE INVENTION

The invention relates to an optical recording medium comprising first and second substrates wherebetween there is arranged at least one first photosensitive layer comprising a front face for receiving optical radiation, by means of the second substrate, during writing and/or reading operations.

### STATE OF THE ART

Optical recording, for example on CD-R (Compact Disc Recordable) and DVD-R (Digital Versatile Disc Recordable) type media is most commonly achieved by means of a layer of colorant material deposited on a plastic substrate and covered by a reflecting metal layer. However, irreversible optical recording technologies in colorant materials sometimes present high costs, in particular as far as the price of the colorants and the manpower costs for the colorant handling stages are concerned.

It has also been proposed to achieve optical recording media using inorganic materials. Inorganic materials present an advantage in terms of production cost and performance at high linear speeds. There are different methods of writing in a layer of inorganic material. The most widely studied irreversible technique consists in forming marks by laser ablation. The presence of the mark results in a local reduction of the reflection of a laser beam on the surface of the disk. This reduction of the reflection is read with a lower laser power.

However, the tests carried out do not correspond to the current written specifications. The powers used when the tests were performed were in fact comprised between 40 mW and 300 mW and the dimensions of the marks were about 10 μm, whereas the writing powers used at present to write on a DVD-R should be about 10 mW and the diameter of a mark should be about 400 nm. Many materials have been studied, in particular tellurium and its alloys with germanium, selenium and antimony. But they do not generally enable good quality writing and sufficiently high data storage densities to be obtained. In addition, tellurium is unstable at ambient temperature and presents risks of oxidation and crystallization. Writing by laser ablation can cause formation of a pad around the marks formed by the laser beam. Such a pad may result in noise on the signal. This is why recording technologies using organic colorants have been preferred up to now.

### OBJECT OF THE INVENTION

The object of the invention is to provide an optical recording medium operating by means of at least one photosensitive layer and able to present a high data storage density.

According to the invention, this object is achieved by the fact that a first deformable layer, transparent to the optical radiation, is arranged between the first photosensitive layer and the second substrate.

According to a development of the invention, the first photosensitive layer comprises an inorganic material.

According to another development of the invention, the first substrate comprises a patterned front face.

According to a preferred embodiment, the first deformable layer comprises a polymer previously cross-linked by a light radiation, preferably chosen from silicones.

According to another feature of the invention, the first deformable layer has a thickness less than or equal to 200 micrometers.

According to another development of the invention, the medium comprises at least one semi-transparent second photosensitive layer, arranged between the first deformable layer and the second substrate, a second deformable layer being arranged between the second photosensitive layer and the second substrate.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 is a schematic representation, in cross-section, of a first embodiment of a medium according to the invention.

FIGS. 2 and 3 schematically represent, in cross-section, a part of a medium according to the invention, respectively before and after writing.

FIGS. 4 and 5 are respectively schematic representations, in cross-section, of second and third embodiments of a medium according to the invention.

### DESCRIPTION OF PARTICULAR EMBODIMENTS

An optical recording medium, for example an irreversible medium, is preferably in the form of an optical disc, but it can also be in the form of a chip card. It comprises first and second substrates wherebetween at least one photosensitive layer, preferably comprising an inorganic material, is arranged. Recording of the medium is based on localized deformation of the photosensitive layer when the front face thereof receives an optical radiation, by means of the second substrate. The second substrate is therefore transparent to the optical radiation, which is preferably a focused, power-modulated laser beam.

The photosensitive layer preferably comprises an inorganic material able to be locally deformed by the action of an optical radiation and it must ensure sufficient reflection and partial absorption of the optical radiation light. The energy absorbed par the photosensitive layer induces a local temperature rise in the layer which causes a local deformation thereof, in the form of a bubble or a hole, notably according to the nature of the inorganic material of the photosensitive layer. The holes or bubbles formed constitute marks in the photosensitive layer. As the marks of the photosensitive layer are less reflecting than the non-deformed zones of the layer, it is then possible to read the medium by detecting the marks formed. The lengths of the marks and the spaces therebetween thus enable data to be encoded. The length of the marks can also be made to vary by applying a specific modulation of the power of the optical radiation applied, said specific power modulation corresponding to a writing strategy.

The shape of the marks is determined by the type of materials of the photosensitive layer. The materials able to form holes, such as materials with a tellurium alloyed with antimony or selenium base, have thus been described in an article by M. Terao et al. (“Chalcogenide thin films for laser-beam recordings by thermal creation of holes”, J. Appl. Phys. 50(11), November 1979, pages 6881 to 6886).

However, to achieve larger data storage densities, it is preferable to prefer materials able to form bubbles. Such materials generally have a relatively high melting point and they comprise at least one element that is easy to spray. In the case of writing by formation of bubbles, the composition of the material of the photosensitive layer is generally adjusted so as to guarantee a quality of bubble formation compatible with a good standard deviation of the jitter engraved on the disc. Sulphur-based, selenium-based, tellurium-based, arsenic-based, zinc-based, cadmium-based and phosphorus-based alloys can be used. For example, the photosensitive layer can comprise a zinc telluride alloy (Zn—Te), a zinc selenide alloy (ZnSe), a phosphate and zinc alloy (PZn), an arsenic and zinc alloy (AsZn) or a cadmium telluride alloy (CdTe). For a Zn—Te layer made from zinc telluride alloy, the most suitable proportion is 65% atomic of zinc for 35% atomic of tellurium, and the thickness of the layer is preferably comprised between 15 and 50 nm, and preferably equal to 40 nm.

According to the invention, a deformable layer, transparent to the optical radiation and non-birefringent, is arranged between the photosensitive layer and the second substrate, so that the optical radiation passes therethrough before reaching the photosensitive layer. The deformable layer preferably has a Shore A hardness comprised between 20 and 80 and a thickness less than or equal to 200 μm, and more particularly comprised between 2 μm and 100 μm. It preferably comprises a polymer previously cross-linked by a light radiation, such as polymers chosen from silicones. More particularly, the polymer can be polydimethylsiloxane (PDMS) and the viscosity of the polymer is preferably less than 600 mPa·S before cross-linking. The deformable layer can also be “bi-component”, i.e. comprising components that polymerize when they are mixed, for example Sylgard 184® or Loctite 5091®. The deformable layer is a layer able to follow the deformations of the photosensitive layer when the writing operations are performed on the photosensitive layer. The writing optical radiation passes through both the deformable layer and at least a part of the photosensitive layer, which enables deformations to be created in the deformable layer that are added to the protrusions created in the photosensitive layer.

The first and second substrates are preferably made of plastic material, for example polycarbonate (PC) or polymethylmethacrylate (PMMA), and they are achieved by molding. The first substrate comprises a free rear face and a front face that is preferably patterned. Thus, the front face comprises a groove, preferably spiral-shaped and enabling precise data writing and reading by means of an automatic focusing control and track monitoring system. Patterning of the front face of the first substrate also enables track monitoring to be performed, the relief of the front face thus being transmitted to the photosensitive layer and to the deformable layer when the medium is produced. In this case, the first substrate comprises raised parts on which the laser beam focuses. The thickness of the substrates and the pitch of the spiral for the first substrate are variable, depending on the specifications imposed by the type of recording medium required. For example, for a DVD or for a HD-DVD (High Definition-DVD), the first substrate has a thickness of 0.6 mm whereas to produce an optical disc using a blue laser, more commonly known under the name of “Blu-Ray” disc, the thickness of the first substrate is 1.1 mm. Furthermore, the pitch of the spiral of the first substrate is 0.74 μm for a DVD and 0.32 μm for a “Blu-Ray DVD” or HD-DVD. Conventionally, the raised parts on the first substrate have a maximum width equal to a half of the period of the spiral.

The second substrate is non-birefringent and preferably comprises flat front and rear faces. Its thickness is determined by the type of format of the required medium. Thus, for a DVD, the sum of the thicknesses of the second substrate and of the layers arranged between the first and second substrates must be about 0.6 mm, whereas for a “Blu-Ray DVD” disc, the sum of the thicknesses must be about 100 μm.

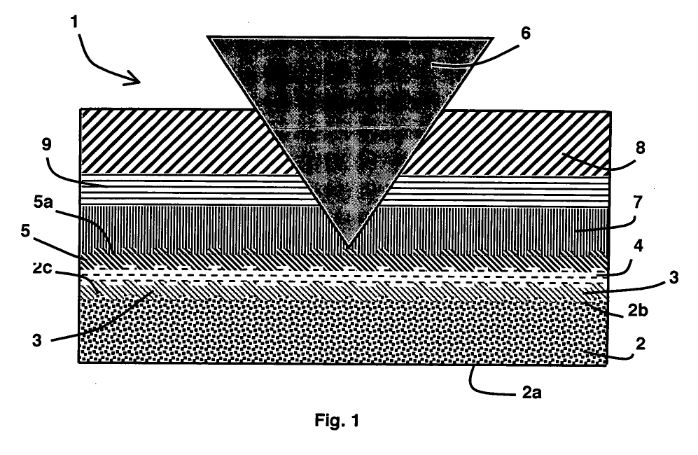

For example, in a first embodiment represented in FIG. 1, an optical recording medium 1 comprises a first substrate 2 made of plastic. The first substrate 2 comprises a free rear face 2a and a patterned front face 2b. The front face 2b thus comprises raised parts 2c designed to enable writing and reading of the medium 1 on zones arranged above the raised parts 2c.

A metal layer 3, preferably having a thickness greater than or equal to 15 nanometers and more particularly a thickness comprised between 20 nanometers and 30 nanometers, is arranged on the front face of the first substrate 2, between the first substrate 2 and a photosensitive layer 5. The metal layer 3, designed to improve the optical properties of the photosensitive layer 5, is more particularly suitable when the photosensitive layer 5 is hardly absorbent in a predetermined wavelength range, for example when the photosensitive layer is formed by a zinc telluride and the wavelength range of the optical radiation is comprised between 630 nm and 650 nm. The metal layer 3 also enables the thermal behaviour of the photosensitive layer 5 to be improved. It can be formed by silver, gold, aluminium or copper.

A layer made of dielectric material 4 can also be arranged between the metal layer 3 and the photosensitive layer 5. The dielectric material layer 4 also enables the optical properties of the photosensitive layer 5 and the writing quality to be improved. It preferably comprises zinc sulphide (ZnS), zinc sulphide and silicon dioxide (ZnS—SiO₂), silicon nitride (Si₃N₄) or silicon carbide (SiC), and it has a small thickness, preferably less than 20 nm.

The zinc telluride photosensitive layer 5, designed to be locally deformed by the action of an optical radiation 6, has a thickness comprised between 20 nm and 30 nm and it comprises a front face 5a whereby the optical radiation 6 is received. The two layers, respectively made of metal and of dielectric material, enable an inorganic stacking to be formed with the photosensitive layer that is able to obtain a high initial reflection while keeping a good writing sensitivity and a good contrast. In the case of a writing mechanism by formation of holes, the two layers, respectively made of metal and of dielectric material, can be replaced by a layer protecting against oxidation made of inorganic material. The inorganic material is preferably alumina and the layer has a thickness of 7 mm.

A deformable layer 7, made from PDMS and having a thickness less than or equal to 100 μm, is arranged on the front face 5a of the photosensitive layer 5. In so far as the deformable layer 7 has a sufficient adherence, it can be placed directly in contact with the rear face 8a of a second substrate 8. If not, as represented in FIG. 1, a layer of glue 9 is arranged between the deformable layer 7 and the second substrate 8, so as to ensure a good join between the two. The layer of glue 9 is preferably deposited by spin coating on the deformable layer 7 and is then solidified by means of a light radiation passing through the second substrate 8, once the latter has been arranged on the assembly formed by the layer of glue 9, the deformable layer 7, the inorganic stacking and the first substrate 2. To assemble the first and second substrates, a glue film of adhesive contact type also called “Pressure sensitive adhesive” or PSA, acting as glue layer 9, can also be deposited, by lamination, on the rear face 8a of the second substrate 8.

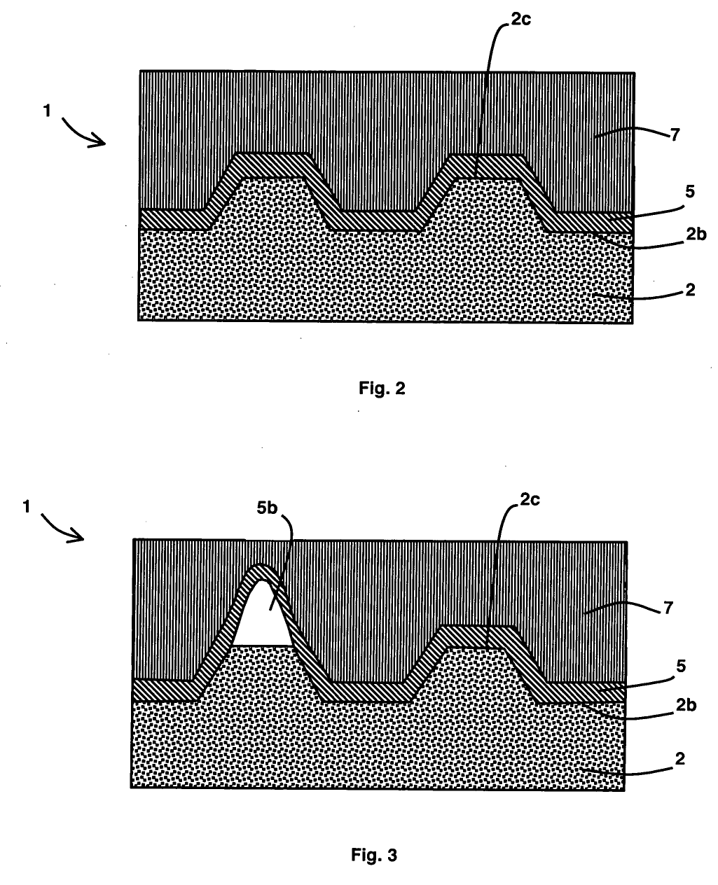

Arranging a deformable layer 7 on the front face of the photosensitive layer fosters creation of precise marks in the photosensitive layer 5. Indeed, when the photosensitive layer 5 deforms, the deformable layer 7 has a deformation of the same type, accompanying the deformation of the photosensitive layer. The deformable layer 7 thus enables widening of the writing marks due, in particular, to diffusion of the optical radiation heat when writing is performed, to be limited. The deformable layer 7 thus enables marks of better quality to be obtained. FIGS. 2 and 3 illustrate, respectively before and after a writing step, a part of the recording medium 1 comprising a first substrate 2 with a patterned front face 2b whereon a photosensitive layer 5 and a deformable layer 7 are successively deposited. In this way, after the medium has been exposed to an optical radiation, a bubble 5b forms in the photosensitive layer 5, above a raised part 2c, and the deformable layer 7 also undergoes a deformation, the shape of this deformation being complementary to that of the bubble 5b.

In an alternative embodiment, a metal layer preferably having a thickness less than or equal to 15 nm can be arranged between the photosensitive layer 5 and the deformable layer 7 so as to improve the reflection of the photosensitive layer 5. It is preferably made of gold, copper, silver or aluminium. As the metal layer is very thin, it deforms in the same way as the photosensitive layer 5. A transparent and very thin layer protecting against oxidation can also be arranged between said metal layer and the deformable layer 7.

Table I below illustrates several examples of structures of different recording media according to the invention.

TABLE I

| | | 1^{st} Layer of | 2^{nd} Layer of | | | |
|---|---|---|---|---|---|---|
| Type of | First | inorganic | inorganic | | | Second |
| medium | substrate | material | material | Deformable layer | Glue | Substrate |
| DVD R | PC | ZnTe | — | PDMS bi-component | | PC |
| 4.7 Go | 0.6 mm | | | 20 μm | | 0.58 mm |
| DVD R | PC | ZnTe | | PDMS bi-component | Cross- | PC |
| 4.7 Go | 0.6 mm | | | 20 μm | linkable | 0.58 mm |
| | | | | | acrylic glue | |
| Blu-Ray R | PC | ZnTe | | PDMS bi-component | PC (80 μm) | |
| 25 Go | 1.1 mm | | | 100 μm | with a 20 μm film of | |
| | | | | | cross-linkable PDMS | |
| Blu-Ray R | PC | ZnTe | | PDMS bi-component | | |
| 25 Go | 1.1 mm | | | 100 μm | | |
| Blu-Ray R | PC | ZnTe | | | PC (80 μm) | |
| 25 Go | 1.1 mm | | | | with a 20 μm film of | |
| | | | | | cross-linkable PDMS | |
| Blu-Ray R | PC | ZnTe | | | PC | |
| 25 Go | 1.1 mm | | | | 80 μm | |
| DVD R | PC | ZnTe | Very thin | PDMS bi-component | | PC |
| 4.7 Go | 0.6 mm | | metal | 20 μm | | 0.58 mm |
| DVD R | PC | ZnTe | Very thin | PDMS bi-component | Cross- | PC |
| 4.7 Go | 0.6 mm | | metal | 20 μm | linkable | 0.58mm |
| | | | | | acrylic glue | |
| Blu-Ray | PC | ZnTe | Very thin | PDMS bi-component | PC (60 μm) | |
| 25 Go | 1.1 mm | | metal | 20 μm | with a film of PSA | |
| | | | | | glue (20 μm) | |
| Blu-Ray | PC | ZnTe | Very thin | PDMS bi-component | | |
| 25 Go | 1.1 mm | | metal | 100 μm | | |
| Blu-Ray R | PC | ZnTe | Very thin | | PC (80 μm) | |
| 25 Go | 1.1 mm | | metal | | with a PDMS layer | |
| | | | | | (20 μm) | |
| Blu-Ray R | PC | ZnTe | Very thin | PDMS bi-component | PC (80 μm) | |
| 25 Go | 1.1 mm | | metal | 20 μm | | |
| DVD R | PC | Thick metal | ZnTe | PDMS bi-component | | PC |
| 4.7 Go | 0.6 mm | | | 20 μm | | 0.58 mm |
| DVD R | PC | Thick metal | ZnTe | PDMS bi-component | Cross- | PC |
| 4.7 Go | 0.6 mm | | | 20 μm | linkable | 0.58 mm |
| | | | | | acrylic glue | |

| | | | | | |
|---|---|---|---|---|---|
| Blu-Ray R | PC | Thick metal | ZnTe | PDMS bi-component | PC (60 μm) |
| 25 Go | 1.1 mm | | | 20 μm | with a film of PSA |
| | | | | | glue (20 μm) |
| Blu-Ray R | PC | Thick metal | ZnTe | PDMS bi-component | |
| 25 Go | 1.1 mm | | | 100 μm | |
| Blu-Ray R | PC | Thick metal | ZnTe | | PC (80 μm) |
| 25 Go | 1.1 mm | | | | with a PDMS layer |
| | | | | | (20 μm) |
| Blu-Ray R | PC | Thick metal | ZnTe | PDMS bi-component | PC (80 μm) |
| 25 Go | 1.1 mm | | | 20 μm | |

A recording medium having a structure such as those described in the table above presents the advantage of being easy and inexpensive to implement and of enabling a high storage capacity to be achieved. Moreover, it enables a first substrate to be produced comprising a spiral having a depth comprised between 30 nm and 70 nm instead of 180 nm for a medium comprising colorant materials. This small depth makes pressing of the substrate easier and enables shorter manufacturing cycles.

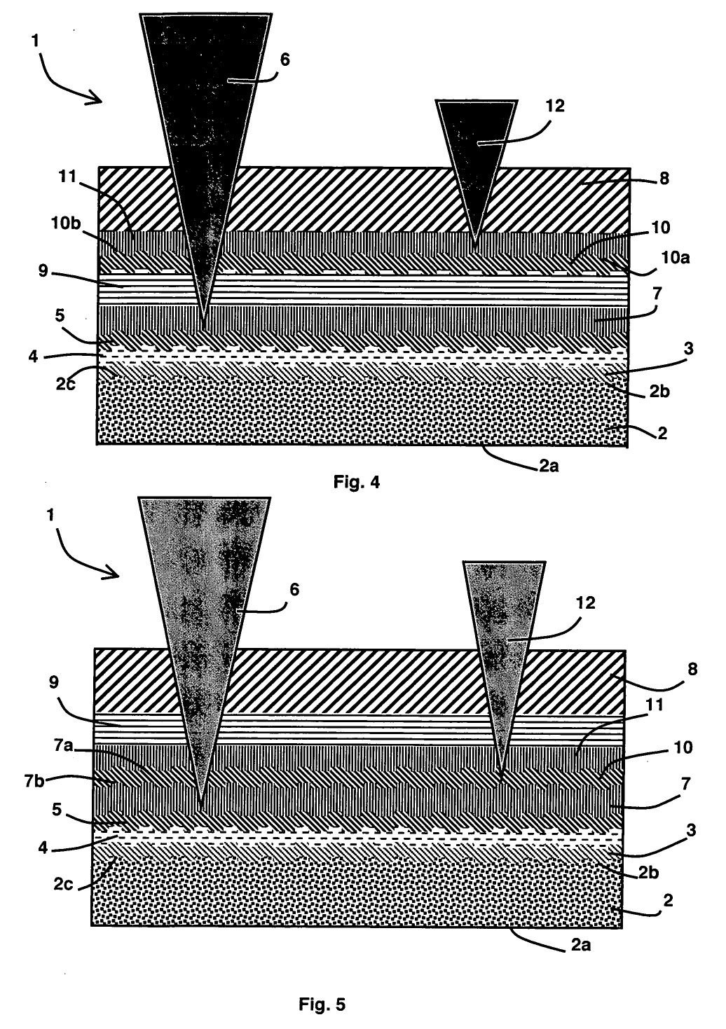

In an alternative embodiment represented in FIGS. 4 and 5, the optical recording medium 1 comprises first and second substrates 1 and 8 wherebetween a stacking of inorganic materials and a first deformable layer 7 are arranged, as represented in FIG. 1. Thus, the first stacking of inorganic materials successively comprises a metal layer 3, a layer made of dielectric material 4 and a first photosensitive layer 5. In order to increase the data storage capacity, the medium 1 also comprises a second photosensitive layer 10, made of semi-transparent inorganic material, whereon a transparent second deformable layer 11 is arranged. The second photosensitive layer 10 is arranged between the first deformable layer 7 and the second substrate 8 and the second deformable layer 11 is arranged between the second photosensitive layer 10 and the second substrate 8.

In FIG. 4, the medium 1 is achieved by assembling the first and second substrates 2 and 8, which respectively comprise at least one photosensitive layer and one deformable layer. Assembly is performed by means of a layer of glue 9 deposited between the first deformable layer 7 and the second photosensitive layer 10. In the same way as the premier substrate 2, the second photosensitive layer 10 comprises a patterned front face 10a, i.e. the front face 10a comprises raised parts 10b designed to focus a second optical radiation 12. It is then possible to write and read the optical recording medium on two levels corresponding to the first and second photosensitive layers. This enables the recording capacity of the medium to be substantially doubled. Thus, in the case of a DVD type medium, it is possible to obtain a capacity of 8.5 Go instead of 4.7 Go.

In FIG. 5, the first substrate initially supports the stacking of preferably inorganic materials, the first deformable layer 7, the second photosensitive layer 10 and the second deformable layer 11. The second substrate 8 is then fixed to the assembly by means of a layer of glue 9 arranged between the second deformable layer and the second substrate 8. In this case, the front face of the second photosensitive layer 10 is flat whereas the first deformable layer 7 comprises a patterned front face 7a. Thus, the front face 7a of the deformable layer comprises raised parts 7b designed to focus the second optical radiation 12.

In an alternative embodiment, a layer of polymer, harder than the deformable layers, is spin coated then cross-linked on the first deformable layer 7. In this case, the front face of the first deformable layer 7 is flat and the harder polymer layer comprises a patterned front face. Such a layer enables the orientation of the deformations of the photosensitive layers to be controlled when writing is performed.

The invention is not limited to the embodiments described above. Thus, the first substrate can be absorbent. It can therefore be colored on the surface or in volume. Furthermore, FIGS. 1 to 5 being schematic representations of particular embodiments, for the sake of clarity, the thicknesses of the different layers represented in FIGS. 1 to 5 are not proportional.

1-17. (canceled)

18. Optical recording medium comprising first and second substrates wherebetween there is arranged at least one first photosensitive layer comprising a front face for receiving optical radiation, by means of the second substrate, during writing and/or reading operations, medium wherein a first deformable layer, transparent to the optical radiation, is arranged between the first photosensitive layer and the second substrate.

19. Medium according to claim 18, wherein the first photosensitive layer comprises an inorganic material.

20. Medium according to claim 18, wherein the first substrate comprises a patterned front face.

21. Medium according to claim 18, wherein the first deformable layer comprises a polymer previously cross-linked by a light radiation.

22. Medium according to claim 20, wherein the polymer is chosen among silicones.

23. Medium according to claim 18 wherein the first deformable layer has a thickness less than or equal to 200 micrometers.

24. Medium according to claim 18, wherein the medium comprises a dielectric layer arranged between the first substrate and the first photosensitive layer.

25. Medium according to claim 18, wherein the medium comprises a first metal layer arranged between the first substrate and the first photosensitive layer.

26. Medium according to claim 18, wherein the medium comprises a layer protecting against oxidation arranged between the first substrate and the first photosensitive layer.

27. Medium according to claim 18, wherein the medium comprises a second metal layer arranged between the first photosensitive layer and the first deformable layer.

28. Medium according to claim 27, wherein a layer protecting against oxidation, transparent to the optical radiation, is arranged between the second metal layer and the first deformable layer.

29. Medium according to claim 18, wherein the medium comprises at least one semi-transparent second photosensitive layer, arranged between the first deformable layer and the second substrate, a second deformable layer being arranged between the second photosensitive layer and the second substrate.

30. Medium according to claim 29, wherein the second photosensitive layer comprises an inorganic material.

31. Medium according to claim 29, wherein the second photosensitive layer comprises a patterned front face.

32. Medium according to claim 29, wherein the first deformable layer comprises a patterned front face.

33. Medium according to claim 18, wherein the medium is in the form of an optical disc.

34. Medium according to claim 18, wherein the medium is in the form of a chip card.
